(19) United States
(12) Patent Application Publication
(10) Pub. No.: US 2025/0078092 A1
(43) Pub. Date: Mar. 6, 2025

(54) METHOD AND SYSTEM FOR MANAGING COMPLIANCE CONTROLS TO MAINTAIN THE REGULATORY COMPLIANCE OF A REGULATED NETWORK

(71) Applicant: JPMorgan Chase Bank, N.A., New York, NY (US)

(72) Inventors: Srinivasa Reddy MALIREDDY, Tampa, FL (US); Raghu HARINATHAN, Edison, NJ (US); Ajay RADHAKRISHNAN, Bangalore (IN); Sujith JAGADEESH, Bangalore (IN); Mani Shankar SRIRAM, Lithia, FL (US); Satyanarayan B KOMANDUR, Tampa, FL (US)

(73) Assignee: JPMorgan Chase Bank, N.A., New York, NY (US)

(21) Appl. No.: 18/380,900

(22) Filed: Oct. 17, 2023

(30) Foreign Application Priority Data
Sep. 4, 2023 (IN) 202311059429

(51) Int. Cl. G06Q 30/018; H04L 41/16

(52) U.S. Cl. CPC G06Q 30/018; H04L 41/16

(57) ABSTRACT

A system for managing a regulated network of network controls to maintain compliance with applicable regulations. The system may comprise instructions that, when executed, cause a processor to: monitor, a network data source, for new regulatory data that pertains to the regulated network; identify new regulatory data that has been obtained from the network data source; determine whether the new regulatory data requires changes to existing network controls from among the network controls; after determining that the new regulatory data requires the changes, implement the changes; determine whether the first set of new regulatory data requires modifying the network controls to include new network controls that pertain to the network; and after determining that the new regulatory data requires the modifying, add the new network controls to the network controls.

### CROSS-REFERENCE TO RELATED APPLICATIONS

This application claims priority benefit from Indian Application No. 202311059429, filed Sep. 4, 2023, which is hereby incorporated by reference in its entirety.

### BACKGROUND

### 1. Field of the Invention

The field of the invention disclosed herein generally relates to a system for mapping technology-related regulations to controls and policies and, more particularly, to a method, system, and computer-readable storage medium for implementing technology for leveraging artificial intelligence and machine learning (AI/ML) to map technology-related regulations to the internal controls and policies of a regulated computer network.

### 2. Background of the Invention

The management of a large computer network typically requires a significant amount of resources, especially when dealing with the computer network of an enterprise that is subject to one or more government regulations. For example, computer networks that are subject to one or more government regulations must not only remain compliant with those regulations, but such compliance must also remain current in order to account for any pertinent changes to these regulations.

Unfortunately, there are no technical solutions currently available for maintaining the currency of a regulated computer network's compliance by accounting for any pertinent changes to the network's regulations. Therefore, the discovery, triaging, and decomposition (into citations) of information relating to applicable regulatory changes, as well as any subsequent changes that are required to align one or more compliance controls with changes to applicable regulations, must be performed manually. However, the manual performance of such functions is time-consuming and, thereby, prevents new citation-to-control mappings from being published to a regulated computer network's system of record (SOR) without delay. Additionally, over recent years, the frequency of pertinent changes that are typically made to regulations that pertain to such a network, has increased beyond the point that makes the network's continuous compliance with such regulations infeasible to achieve manually.

In other words, due to the frequency of pertinent changes that usually arise with regulations that pertain to the typical computer network of a regulated enterprise, it is no longer feasible to manually maintain such a network's compliance continuously, because the time consumption of such an approach will eventually result in one or more durations where the network will be noncompliant (i.e., violate one or more regulations).

Accordingly, there is a need in the field of the herein-disclosed invention for a technical solution to the foregoing limitation(s) in the technology of existing approaches to maintaining a regulated network's compliance with applicable regulations.

### SUMMARY

The present disclosure, through one or more of its various aspects, embodiments, and/or specific features or sub-component, provides, inter alia, various systems, servers, devices, methods, media, programs and platforms for mapping technology-related regulations to controls and policies in order to manage a regulated computer network's compliance controls and continuously maintain the regulated computer network's compliance with regulations pertaining to that network mapping technology-related regulations to controls and policies.

According to an aspect of the present disclosure, a method is provided for managing a regulated network of a plurality of network controls to maintain compliance with applicable regulations. The method may comprise: monitoring, at least one network data source, for new regulatory data that pertains to the regulated network; identifying a first set of new regulatory data that has been obtained from the at least one network data source; determining whether the first set of new regulatory data requires a first set of changes to a first set of existing network controls from among the plurality of network controls; after determining that the first set of new regulatory data requires the first set of changes, implementing the first set of changes to the first set of existing network controls; determining whether the first set of new regulatory data requires modifying the plurality of network controls to include a first set of new network controls that pertain to the network; and after determining that the first set of new regulatory data requires the modifying, adding the first set of new network controls to the plurality of network controls.

In the method, each respective network control among the plurality of network controls may comprise at least one from among: a respective network control categorization that is determined according to a network control hierarchy; and a respective set of relevant keywords and keyphrases that is associated with the respective network control.

In the method, the network control hierarchy may comprise a set of domains that may each comprise a set of objectives that may each comprise a set of procedures.

The method may further comprise utilizing an artificial intelligence and machine learning (AI/ML) model to perform at least one from among: the monitoring; the identifying; the determining whether the first set of changes is required; and the determining whether the modifying is required. The AI/ML model may have been trained with the plurality of network controls.

In the method, the identifying may further comprise: identifying a first set of relevant regulatory data that comprises at least one from among a relevant keyword and a relevant keyphrase; and identifying when the first set of relevant regulatory data comprises the first set of new regulatory data. The first set of new regulatory data may pertain to a first set of network requirements for which the plurality of network controls does not account.

The method may further comprise: determining, based on the at least one from among the relevant keyword and the relevant keyphrase and at least one corresponding relevant network regulation that corresponds to the at least one from among the relevant keyword and the relevant keyphrase, a corresponding network control categorization of the first set of relevant regulatory data.

In the method, the first set of relevant regulatory data may comprise the first set of new regulatory data when a first similarity between: the corresponding network control categorization; and a respective existing network control categorization of each existing network control among the first set of network controls, falls below an upper threshold.

In the method, the first set of changes may be determined to be required when a second similarity between the corresponding network control categorization and at least one existing network control categorization is above a lower threshold.

In the method, the modifying may be determined to be required when a second similarity between: the corresponding network control categorization; and a respective existing network control categorization of each existing network control among the first set of existing network controls, falls below a lower threshold.

The method may further comprise: utilizing the AI/ML model to recommend, based on a fourth similarity between the corresponding network control categorization and the respective existing network control categorization of each existing network control, at least one new network control that accounts for the first set of new regulatory data.

According to another aspect of the present disclosure, a system is provided for managing a regulated network of a plurality of network controls to maintain compliance with applicable regulations. The system may comprise: a processor; and memory storing instructions. When executed by the processor, the instructions may cause the processor to perform operations. The operations may comprise: monitoring, at least one network data source, for new regulatory data that pertains to the regulated network; identifying a first set of new regulatory data that has been obtained from the at least one network data source; determining whether the first set of new regulatory data requires a first set of changes to a first set of existing network controls from among the plurality of network controls; after determining that the first set of new regulatory data requires the first set of changes, implementing the first set of changes to the first set of existing network controls; determining whether the first set of new regulatory data requires modifying the plurality of network controls to include a first set of new network controls that pertain to the network; and after determining that the first set of new regulatory data requires the modifying, adding the first set of new network controls to the plurality of network controls.

In the system, when the instructions cause the processor to perform operations, each respective network control among the plurality of network controls may comprise at least one from among: a respective network control categorization that is determined according to a network control hierarchy; and a respective set of relevant keywords and keyphrases that is associated with the respective network control.

In the system, when the instructions cause the processor to perform operations, the network control hierarchy may comprise a set of domains that each comprise a set of objectives that each comprise a set of procedures.

In the system, when executed, the instructions may cause the processor to perform further operations comprising utilizing an artificial intelligence and machine learning (AI/ML) model to perform at least one from among: the monitoring; the identifying; the determining whether the first set of changes is required; and the determining whether the modifying is required. The AI/ML model may have been trained with the plurality of network controls.

In the system, when the instructions cause the processor to perform operations, the identifying may further comprise: identifying a first set of relevant regulatory data that comprises at least one from among a relevant keyword and a relevant keyphrase; and identifying when the first set of relevant regulatory data comprises the first set of new regulatory data. The first set of new regulatory data may pertain to a first set of network requirements for which the plurality of network controls does not account.

In the system, when executed, the instructions may cause the processor to perform further operations comprising: determining, based on the at least one from among the relevant keyword and the relevant keyphrase and at least one corresponding relevant network regulation that corresponds to the at least one from among the relevant keyword and the relevant keyphrase, a corresponding network control categorization of the first set of relevant regulatory data.

In the system, when the instructions cause the processor to perform operations, the first set of relevant regulatory data may comprise the first set of new regulatory data when a first similarity between: the corresponding network control categorization; and a respective existing network control categorization of each existing network control among the first set of network controls, falls below an upper threshold.

In the system, when the instructions cause the processor to perform operations, the first set of changes may be determined to be required when a second similarity between the corresponding network control categorization and at least one existing network control categorization is above a lower threshold.

In the system, when the instructions cause the processor to perform operations, the modifying may be determined to be required when a second similarity between: the corresponding network control categorization; and a respective existing network control categorization of each existing network control among the first set of existing network controls, falls below a lower threshold.

In the system, when executed, the instructions may cause the processor to perform further operations comprising utilizing the AI/ML model to recommend, based on a fourth similarity between the corresponding network control categorization and the respective existing network control categorization of each existing network control, at least one new network control that accounts for the first set of new regulatory data.

According to yet another aspect of the present disclosure, a non-transitory computer-readable medium is provided for managing a regulated network of a plurality of network controls to maintain compliance with applicable regulations. The computer-readable medium may store instructions that, when executed by a processor, cause the processor to perform operations. The operations may comprise: monitoring, at least one network data source, for new regulatory data that pertains to the regulated network; identifying a first set of new regulatory data that has been obtained from the at least one network data source; determining whether the first set of new regulatory data requires a first set of changes to a first set of existing network controls from among the plurality of network controls; after determining that the first set of new regulatory data requires the first set of changes, implementing the first set of changes to the first set of existing network controls; determining whether the first set of new regulatory data requires modifying the plurality of network controls to include a first set of new network controls that pertain to the network; and after determining that the first set of new regulatory data requires the modifying, adding the first set of new network controls to the plurality of network controls.

In the computer-readable medium, when the instructions cause the processor to perform operations, each respective network control among the plurality of network controls may comprise at least one from among: a respective network control categorization that is determined according to a network control hierarchy; and a respective set of relevant keywords and keyphrases that is associated with the respective network control.

In the computer-readable medium, when the instructions cause the processor to perform operations, the network control hierarchy may comprise: a set of domains that each comprise a set of objectives that each comprise a set of procedures.

In the computer-readable medium, when executed, the instructions may cause the processor to perform further operations comprising utilizing an artificial intelligence and machine learning (AI/ML) model to perform at least one from among the monitoring, the identifying, the determining whether the first set of changes is required, and the determining whether the modifying is required. The AI/ML model may have been trained with the plurality of network controls.

In the computer-readable medium, when the instructions cause the processor to perform operations, the identifying may further comprise: identifying a first set of relevant regulatory data that comprises at least one from among a relevant keyword and a relevant keyphrase; and identifying when the first set of relevant regulatory data comprises the first set of new regulatory data. The first set of new regulatory data may pertain to a first set of network requirements for which the plurality of network controls does not account.

In the computer-readable medium of claim 24, when executed, the instructions may cause the processor to perform further operations comprising determining, based on the at least one from among the relevant keyword and the relevant keyphrase and at least one corresponding relevant network regulation that corresponds to the at least one from among the relevant keyword and the relevant keyphrase, a corresponding network control categorization of the first set of relevant regulatory data.

In the computer-readable medium, when the instructions cause the processor to perform operations, the first set of relevant regulatory data may comprise the first set of new regulatory data when a first similarity between: the corresponding network control categorization; and a respective existing network control categorization of each existing network control among the first set of network controls, falls below an upper threshold.

In the computer-readable medium, when the instructions cause the processor to perform operations, the first set of changes may be determined to be required when a second similarity between the corresponding network control categorization and at least one existing network control categorization is above a lower threshold.

In the computer-readable medium, the modifying may be determined to be required when a second similarity between: the corresponding network control categorization; and a respective existing network control categorization of each existing network control among the first set of existing network controls, falls below a lower threshold.

In the computer-readable medium, when executed, wherein the instructions may cause the processor to perform further operations comprising: utilizing the AI/ML model to recommend, based on a fourth similarity between the corresponding network control categorization and the respective existing network control categorization of each existing network control, at least one new network control that accounts for the first set of new regulatory data.

Thereby, the invention disclosed herein improves existing technology by managing a regulated computer network's compliance controls in a manner that continuously maintains the network's compliance with regulations pertaining to that network.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 is a diagram of an exemplary computer system.

FIG. 2 is a diagram of an exemplary network environment for mapping technology-related regulations to internal controls and policies of a regulated network.

FIG. 3 is a diagram of an exemplary perspective of a network environment that maps technology-related regulations to internal controls and policies of a regulated network.

FIG. 4 is a flowchart of an exemplary process for mapping technology-related regulations to internal controls and policies of a regulated network.

FIG. 5 is a flowchart of an exemplary process for evaluating data in order to map technology-related regulations to internal controls and policies of a regulated network.

FIG. 6 is a procedure for implementing a change to internal controls and policies that maps to a corresponding technology-related regulatory change.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out steps necessary to implement the methods of the examples of this technology that are described and illustrated herein.

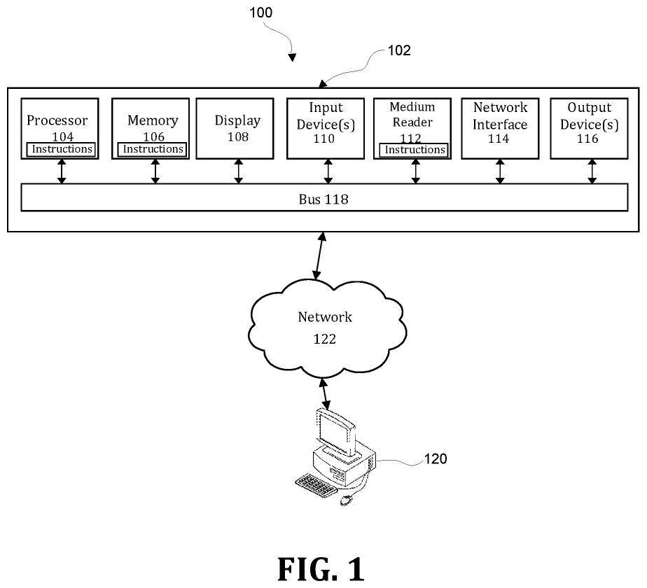

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for implementing a network compliance controls management tool that manages a regulated network of a plurality of network controls to maintain compliance with applicable regulations.

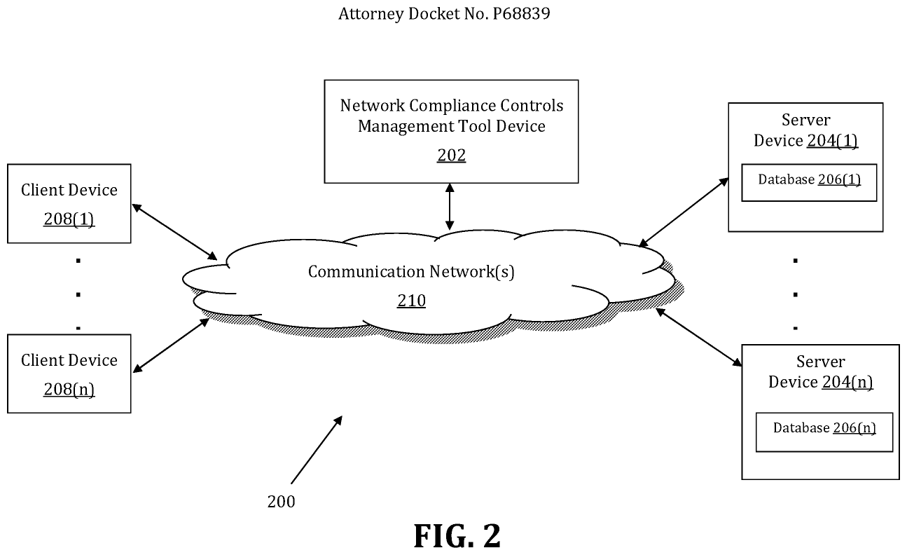

Referring to FIG. 2, a schematic of an exemplary network environment 200 an exemplary network environment that maps technology-related regulations to controls and policies and, thereby manages a regulated computer network's compliance controls and continuously maintain the regulated computer network's compliance with regulations pertaining to that network. In an exemplary embodiment, a technology-related regulations-to-controls & policies mapping may be implemented on any networked computer platform, such as, for example, a personal computer (PC).

A method for managing a regulated network of a plurality of network controls to maintain compliance with applicable regulations may be implemented by a Network Compliance Controls Management Tool (NCCMT) device 202. The NCCMT device 202 may be the same or similar to the computer system 102 as described with respect to FIG. 1. The NCCMT device 202 may be a rack-mounted server in a datacenter, an embedded microcontroller (MCU) in an electronic device, or another type of headless system, which is a computer system or device that is configured to operate without a monitor, keyboard and mouse. The NCCMT device 202 may store one or more applications that can include executable instructions that, when executed by the NCCMT device 202, cause the NCCMT device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the NCCMT device 202 itself, may be located in virtual server(s) running in a cloud-based computing environment rather than being tied to one or more specific physical network computing devices. Also, the application(s) may be running in one or more virtual machines (VMs) executing on the NCCMT device 202. Additionally, in one or more embodiments of this technology, virtual machine(s) running on the NCCMT device 202 may be managed or supervised by a hypervisor.

In the network environment 200 of FIG. 2, the NCCMT device 202 is coupled to a plurality of server devices 204(1)-204(n) that hosts a plurality of databases 206(1)-206(n), and also to a plurality of client devices 208(1)-208(n) via communication network(s) 210. A communication interface of the NCCMT device 202, such as the network interface 114 of the computer system 102 of FIG. 1, operatively couples and communicates between the NCCMT device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the NCCMT device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, computer readable media, and NCCMT devices that efficiently implement a method for a Network Compliance Controls Management Tool that improves the overall speed, ease, and user experience of cyber defense capability assessment tasks.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The NCCMT device 202 may be a standalone device or integrated with one or more other devices or apparatuses, such as one or more of the server devices 204(1)-204(n), for example. In one particular example, the NCCMT device 202 may include or be hosted by one of the server devices 204(1)-204(n), and other arrangements are also possible. As another example, the NCCMT device 202 may be integrated with one or more other devices or apparatuses, such as one or more of the client devices 208(1)-208(n). Moreover, one or more of the devices of the NCCMT device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the NCCMT device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to a variety of databases.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the NCCMT device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the NCCMT device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the NCCMT device 202, the server devices 204(1)-204(n), the databases 206(1)-206(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the NCCMT device 202, the server devices 204(1)-204(n), the databases 206(1)-206(n), or the client devices 208(1)-208(n), for example, may be configured to operate as virtual instances on the same physical machine. In other words, one or more of the NCCMT device 202, the server devices 204(1)-204(n), the databases 206(1)-206(n), or the client devices 208(1)-208(n) may operate on the same physical device rather than as separate devices communicating through communication network(s) 210. Additionally, there may be more or fewer NCCMT devices 202, server devices 204(1)-204(n), databases 206(1)-206(n), or client devices 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

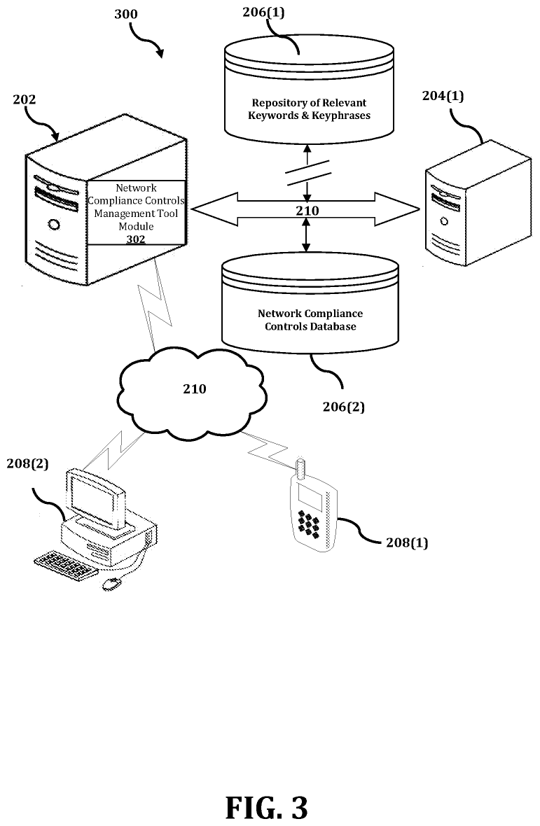

The NCCMT device 202 is described and illustrated in FIG. 3 as including network compliance controls management tool module 302, although it may include other rules, policies, modules, databases, or applications, for example. As will be described below, network compliance controls management tool module 302 is configured to manage network controls to maintain network compliance with regulations that pertain to network resources. Network compliance controls management tool module 302 may include software that is based on a microservices architecture.

Network compliance controls management tool module 302 may be integrated with one or more devices or apparatuses, such as client devices 208(1)-208(n), where network compliance controls management tool module 302 may be implemented as an application or as an addon or plugin to another application of the one or more devices or apparatuses, and where network compliance controls management tool module 302 may execute in the background.

An exemplary process 300 for application of a Network Compliance Controls Management Tool to an aspect of the network environment of FIG. 2 is illustrated as being executed in FIG. 3. Specifically, a first client device 208(1) and a second client device 208(2) are illustrated as being in communication with NCCMT device 202. In this regard, the first client device 208(1) and the second client device 208(2) may be “clients” of the NCCMT device 202 and are described herein as such. Nevertheless, it is to be known and understood that the first client device 208(1) and/or the second client device 208(2) need not necessarily be “clients” of the NCCMT device 202, or any entity described in association therewith herein. Any additional or alternative relationship may exist between either or both of first client device 208(1), second client device 208(2) and NCCMT device 202, or no relationship may exist.

Further, NCCMT device 202 is illustrated as being able to access repository of relevant keywords and keyphrases 206(1), and network compliance controls database(s) 206(2). NCCMT device 202 may comprise a Network Compliance Controls Management Tool that communicates with repository of relevant keywords and keyphrases 206(1). In addition, the Network Compliance Controls Management Tool of NCCMT device 202 may also communicate with network compliance controls database(s) 206(2). Network compliance controls management tool module 302 may be configured to access these databases in order to manage network controls to maintain network compliance with regulations that pertain to network resources.

Moreover, NCCMT device 202 may receive and transmit data via communication network(s) 210. NCCMT device 202 may receive and transmit data such as code that is written in one or more of the following dialects: transaction control language (TCL), data manipulation language (DML), data control language (DCL) and data definition language (DFL). Additionally, via communication network(s) 210, NCCMT device 202 may respectively receive and transmit data from and to one or more from among the following devices: server device 204, repository of relevant keywords and keyphrases 206(1), network compliance controls database(s) 206(2) (or another database 206), first client device 208(1), the second client device 208(2), and communication network(s) 210, for example.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The client devices 208(1)-208(n) may represent, for example, computer systems of an organization or database network. The first client device 208(1) represent, for example, one or more computer systems of a department or cluster within the organization or database network. Of course, the first client device 208(1) may include one or more of any of the devices described herein. The second client device 208(2) may be, for example, one or more computer systems of another department or cluster within the organization or database network. Of course, the second client device 208(2) may include one or more of any of the devices described herein.

The process may be executed via the communication network(s) 210, which may comprise plural networks as described above. For example, in an exemplary embodiment, either or both of the first client device 208(1) and the second client device 208(2) may communicate with the NCCMT device 202 via broadband or cellular communication. Of course, these embodiments are merely exemplary and are not limiting or exhaustive.

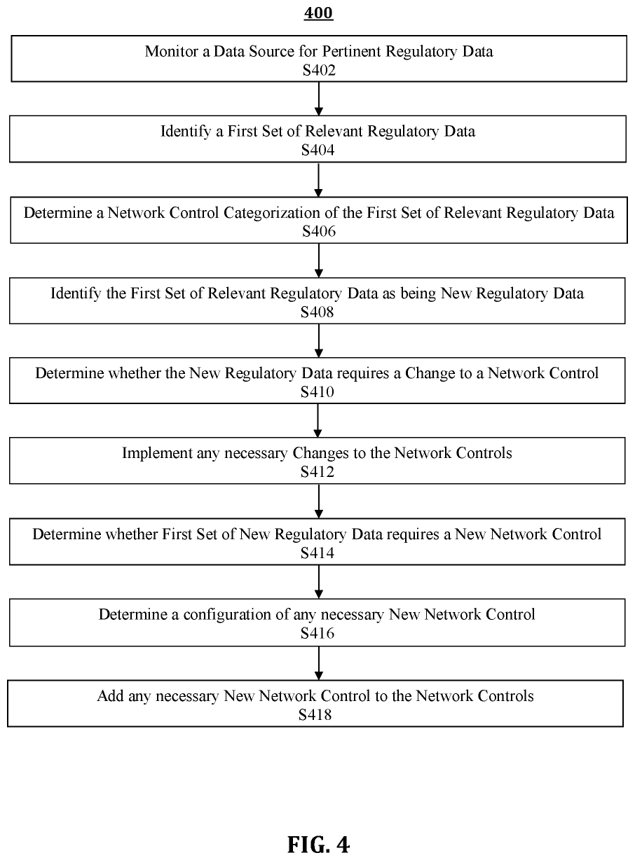

Network compliance controls management tool module 302 may execute a process for a technology-related regulations-to-controls & policies mapping that manages a regulated computer network's compliance controls and, thereby, continuously maintains the regulated computer network's compliance with regulations pertaining to that network. An exemplary process for a technology-related regulations-to-controls & policies mapping is generally indicated at flowchart 400 in FIG. 4.

In process 400 of FIG. 4, at step S402, network compliance controls management tool module 302 monitors a data source for new regulatory information about one or more regulations that pertain to (or govern) a regulated network. The data source may include (but is not limited to) one or more public or private data feeds or servers, such as a server device 204, for example. The regulated network may include (but is not limited to) a virtual network, one or more public or private communication networks, such as communication network(s) 210, and/or a computer host's internal communication network, such as the internal hardware network of bus 118, for example.

In an exemplary embodiment, network compliance controls management tool module 302 may perform step S402 by breaking up (or decomposing) a set of monitored data (e.g., a set of regulatory data) into a plurality of segments (or citations) in order to facilitate that monitored data's evaluation and, then, comparing each of these segments (or citations) to a repository of keywords and keyphrases pertaining to regulations that govern the regulated network. This repository may include (but is not limited to) repository of relevant keywords & keyphrases 206(1).

In a further embodiment, the repository may individually associate each of its keywords and/or keyphrases with one or more respective controls of the regulated network (note: when a keyword or keyphrase is associated with more than one network control, then each network control may have its own respective weighted of association with that keyword or keyphrase). Additionally, step S402 may be performed by an artificial intelligence and machine learning (AI/ML) model, such as a first AI/ML model that is trained to identify regulations that pertain to the regulated network.

At step S404, network compliance controls management tool module 302 identifies a first set of relevant regulatory data, which is obtained data that actually includes one or more keywords and/or keyphrases from a repository of keywords and keyphrases pertaining to regulations that govern the regulated network. The respective control may be a compliance control that imposes limitations that prevent the regulated network from violating one or more regulations. In an exemplary embodiment, the identification of step S404 may be based on a relevancy threshold being exceeded by a correspondence between the first set of relevant regulatory data and a repository such as repository of relevant keywords & keyphrases 206(1). In a further embodiment, step S404 may be performed by the first AI/ML model.

In process 400, the repository of pertinent regulatory keywords and keyphrases may also individually associate each of its keywords and keyphrases with one or more respective network control categorizations. For example, in addition to the one or more respective controls, repository of relevant keywords & keyphrases 206(1) may further individually associate each of its keywords and keyphrases with one or more respective categorizations that relate to a network compliance control.

In an exemplary embodiment, a network control categorization may be based on a network control hierarchy, and the network control categorization may also be based on a group of relevant keywords and keyphrases that are each individually associated with one or more respective network controls. In a further exemplary embodiment, a network control hierarchy may be made up of a set of domains that each include a set of objectives which, in turn, each comprise a set of procedures.

At step S406, network compliance controls management tool module 302 determines a network control categorization of the first set of relevant regulatory data. In an exemplary embodiment, a network control categorization may be based on a relevancy threshold being exceeded by a correspondence between the first set of relevant regulatory data and a repository such as repository of relevant keywords & keyphrases 206(1). In a further embodiment, step S406 may be performed by the first AI/ML model and/or a second AI/ML model that has been trained to determine one or more appropriate network control categorizations for a set of data, such as the first set of relevant data.

In an exemplary embodiment, network compliance controls management tool module 302 may determine the one or more appropriate network control categorizations for a set of data (such as the first set of relevant data) by comparing such data to a repository of keywords and keyphrases such as repository of relevant keywords & keyphrases 206(1). In a further embodiment, the one or more appropriate network control categorizations may be based on a set of matching keywords & keyphrases that result from the comparison.

In yet a further embodiment, one or more corresponding controls for each keyword and/or keyphrase among the set of matching keywords & keyphrases may be assigned a respective weight and/or score that may be utilized to determine the one or more appropriate network control categorizations. In yet an even further embodiment, the one or more appropriate network control categorizations may be based on whether the respective weight(s) and/or score(s) of one or more of the one or more corresponding controls exceed a network categorization threshold.

At step S408, network compliance controls management tool module 302 identifies the first set of relevant regulatory data as being new regulatory data. In an exemplary embodiment, this identification may be based on a lower novelty threshold being exceeded by a correspondence between the first set of relevant regulatory data and each network control of the regulated network. In a further embodiment, novelty of a set of data (such as the first set of relevant regulatory data) may also be based on a comparison between its network control categorization(s) and the respective network control categorization(s) of each network control of the regulated network.

In an exemplary embodiment, step S408 may be performed by one or more from among the first AI/ML model, the second AI/ML model, and/or a third AI/ML model that has been trained to utilize the foregoing details of step S408 to determine whether a set of data (such as the first set of relevant data) includes relevant regulatory information for which no regulated network control actually accounts.

At step S410, network compliance controls management tool module 302 determines whether the new regulatory data of step S408, requires a change to one or more network controls of the regulated network. In an exemplary embodiment, the change to the one or more network controls may be based on an upper novelty threshold exceeding a correspondence for each of a group of separate comparisons between the new regulatory data and each network control whose categorization(s) matches a categorization of the new regulatory data. For example, in an exemplary embodiment, the one or more network controls may include those with the highest correspondence to the new regulated data (although this correspondence must also fall below the upper novelty threshold to require a change to the control(s)).

After step S410, if network compliance controls management tool module 302 determines that the new regulatory data of step S408 requires a change to the one or more network controls of the regulated network then, at step S412, network compliance controls management tool module 302 implements any necessary changes to the one or more network controls. In an exemplary embodiment, the necessary changes may be based on a comparison of one or more network control categorizations of the new regulatory data and the network control categorization(s) of any network control(s) whose categorization(s) matches the categorization of the new regulatory data.

In a further embodiment, the necessary changes may be further based on one or more differences between the one or more controls and any of the matching network controls, for example the necessary changes to the one or more network controls may eliminate the one or more differences. In yet an even further embodiment, the necessary changes may be determined by an AI/ML model such as one or more from among the first AI/ML model, the second AI/ML model, the third AI/ML model, and/or a fourth AI/ML model that is trained to determine the necessary changes based on these differences.

At step S414, network compliance controls management tool module 302 determines whether the new regulatory data requires at least one new network control and, after step S414, if network compliance controls management tool module 302 determines that the new regulatory data requires the at least one new network control then, at step S416, network compliance controls management tool module 302 determines a configuration for the at least one new network control.

In an exemplary embodiment, the at least one new network control may be based on the upper novelty threshold being exceeded by the correspondences for each of the separate comparisons between the new regulatory data and each network control whose categorization(s) matches a categorization of the new regulatory data. In a further exemplary embodiment, the at least one new network control may be based on a comparison of a network control categorization of the new regulatory data and the network control categorization(s) of the network control(s) whose categorization(s) matches the categorization of the new regulatory data.

In yet a further exemplary embodiment, the features, details and/or configuration of the at least one new network control may be determined based on features, details and/or configurations of the one or more network controls that have the highest correspondence to the new regulated data. Additionally, the at least one new network control may be determined by an AI/ML model such as at least one from among the first AI/ML model, the second AI/ML model, the third AI/ML model, the fourth AI/ML model, and/or a fifth AI/ML model that has been trained to determine the at least one new network control based on features, details and/or configurations of the one or more network controls that have the highest correspondence to the new regulated data.

Additionally (or alternatively), after step S414, if network compliance controls management tool module 302 determines that the new regulatory data requires the at least one new network control then, at step S418, network compliance controls management tool module 302 adds the at least one new network control to a database of network controls, such as network compliance control database 206(2). In an exemplary embodiment, the addition of the at least one new network control may be added to a database of network controls may be performed by an AI/ML model such as at least one from among the first AI/ML model, the second AI/ML model, the third AI/ML model, the fourth AI/ML model, the fifth AI/ML model, and/or a sixth AI/ML model that has been trained to append/add such new network controls to a stored set of network controls.

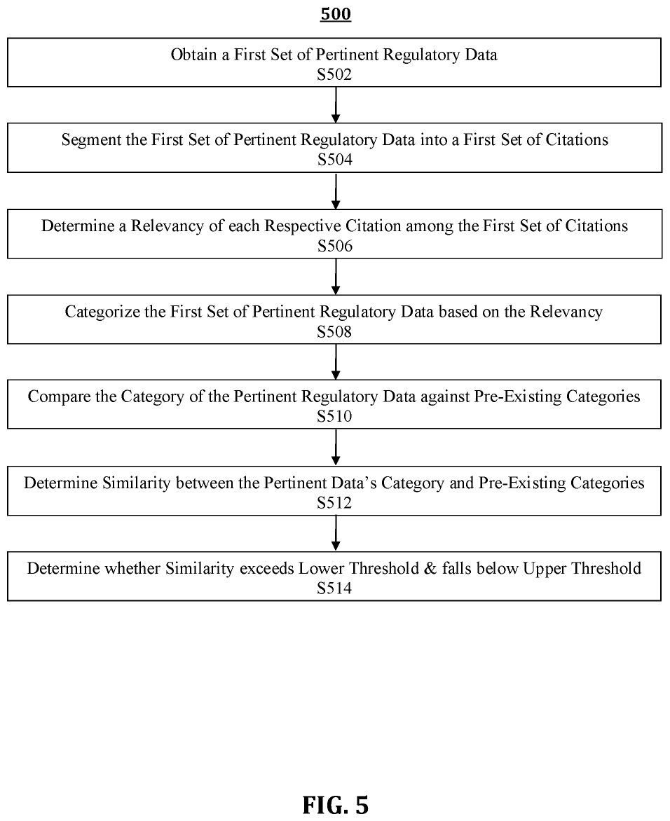

Turning to FIG. 5, an exemplary process for evaluating data for a regulated network in order to maintain its continuous compliance with pertinent regulations is generally indicated at flowchart 500 in FIG. 5. In this process 500 of FIG. 5, at step S502, network compliance controls management tool module 302 obtains a first set of pertinent regulatory data, which may actually be obtained by network compliance controls management tool module 302 itself or by network compliance controls management tool module 302's receipt of the first set of pertinent regulatory data from a corresponding data source. In an embodiment, pertinent regulatory data may refer to all data that has been obtained through a data source such as a server device 204, and the first set of pertinent regulatory data may refer to any portion of the pertinent regulatory data.

At step S504, network compliance controls management tool module 302 segments (or decomposes) the first set of pertinent regulatory data into a first set of citations. In an embodiment, the segmenting of step S504 may break down (or divide) a set of data (such as the first set of pertinent data) in any number of segments. These segments may also be referred to as “citations” because they can be used to pinpoint particular information within a set of data. In a further embodiment, the resulting segments of step S504 may be of any manageable size. For example, each sentence within a set of data may be divided into its own distinct segment of the set of data. However, a set of data may be segmented according to any delineator, such as by dividing each paragraph, section, or item (such as items within a list) from a set of data into its own distinct segment of that set.

At step S506, network compliance controls management tool module 302 determines a relevancy of each respective citation among the first set of citations. In an exemplary embodiment, this relevancy may be based on a comparison between a citation and the contents of a repository such as repository of relevant keywords & keyphrases 206(1). In a further embodiment, this relevancy may also be based on one or more matches that result from the separate comparisons of each respective citation among the first set of citations and the content of a repository such as repository of relevant keywords & keyphrases 206(1).

In yet a further embodiment, this relevancy may be further based on the one or more matches exceeding a citation relevancy threshold. In an embodiment, each of the one or more matches may be assigned its own weight and/or score that is compared to a citation relevancy threshold in order to determine whether citation is actually relevant. In another embodiment, each of these citation relevancies may also may be assigned its own weight and/or score that may be compared to a threshold to determine whether a set of data (such as the first set of pertinent data) is relevant overall.

At step S508, network compliance controls management tool module 302 categorizes the first set of pertinent regulatory data based on the relevancy. In an embodiment, the details of the categorization of step S508 may be substantially the same as, or similar to, the details described above for the categorization that is performed in step S406.

At step S510, network compliance controls management tool module 302 compares the category of the pertinent regulatory data to the one or more categories that are associated with the pre-existing controls of a network (such as the regulated network).

At step S512, network compliance controls management tool module 302 determines a separate similarity between the first set of pertinent data and each pre-existing control. In an exemplary embodiment, the determination of step S512 may be based on the comparison of step S510.

At step S514, network compliance controls management tool module 302 determines whether each separate similarity determined at step S512 exceeds a lower threshold and falls below an upper threshold. In an exemplary embodiment, exceeding the lower threshold indicates that a corresponding set of regulatory data may be considered to include new regulatory data.

In a further embodiment, exceeding the upper threshold indicates that a corresponding set of regulatory data requires at least one new regulatory control. In yet a further embodiment, exceeding the lower threshold while also falling below the upper threshold indicates that a corresponding set of regulatory data requires at least one pre-existing regulatory control of a network (such as the regulated network).

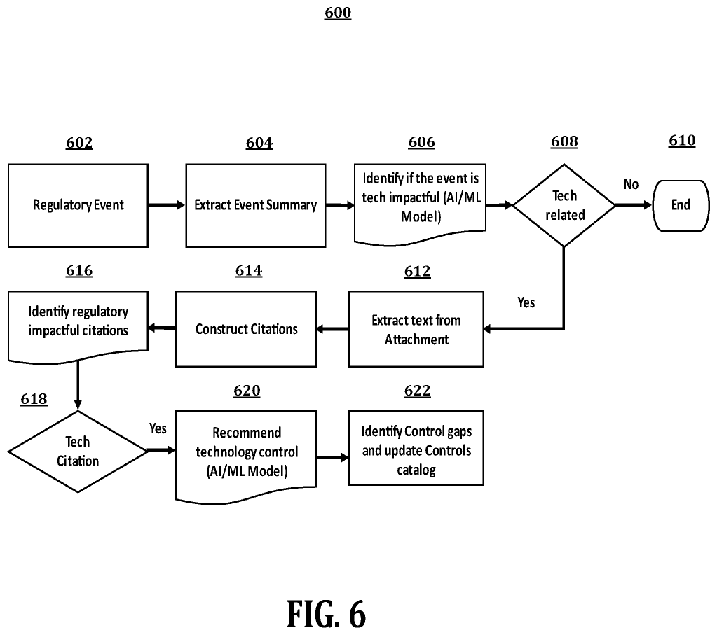

An exemplary process for implementing a procedure for implementing regulatory change(s) within a regulated network in a manner that maintains its continuous compliance with applicable regulations is generally indicated at process 600 in FIG. 6. In this process 600 of FIG. 6, at step S602, network compliance controls management tool module 302 obtains a regulatory event, which may actually be obtained by network compliance controls management tool module 302 itself or by network compliance controls management tool module 302's receipt of the regulatory event from a corresponding data source (such as a server device 204). In an embodiment, such a regulatory event may include information (e.g., a message, update, bulletin, article, or other information) related to a regulation (such as part of an actual regulation) or a regulatory authority such as a government (or government agency).

At step S604, network compliance controls management tool module 302 extracts an event summary from the regulatory event. In an embodiment, such an event summary may include one or more summaries of the regulatory event. In an exemplary embodiment, a summarization of the regulatory event may comprise one or more from among at least one textual summary of the regulatory event, at least one audible summary of the regulatory event, and at least one visual summary of the regulatory event.

At step S606, network compliance controls management tool module 302 identifies whether the regulatory event is tech impactful (tech related). In an embodiment, identifying whether the regulatory event is tech impactful (tech related) may be based on whether the regulatory event impacts any technology (e.g., the regulatory network) managed by network compliance controls management tool module 302. In an exemplary embodiment, the identification of step S606 may be performed by an AI/ML model, such as one or more from among the first AI/ML model, the second AI/ML model, the third AI/ML model, the fourth AI/ML model, the fifth AI/ML model, the sixth AI/ML model and/or a seventh AI/ML model that has been trained to identify whether the regulatory event is tech impactful.

After step S608, network compliance controls management tool module 302 decides how to proceed, at step S610, based on whether the regulatory event is tech related (tech impactful). Hence, the identification of step S608 is a basis for the decision of step S610. Accordingly, in the event that network compliance controls management tool module 302 does not identify the regulatory event as being tech impactful (tech related) then, at step S610, network compliance controls management tool module will proceed to step S610 and end (or terminate) process S600.

Alternatively, after step S608, in the event that network compliance controls management tool module actually does identify the regulatory event as being tech impactful (tech related) then, at step S610, network compliance controls management tool module 302 will proceed to step S612.

At step S612, network compliance controls management tool module 302 extracts text from an attachment (such as an electronic file or any other set of data/information) that comprises the regulatory event. In an embodiment, the extraction of step S612 may be performed using one or more standard text extraction techniques.

At step S614, network compliance controls management tool module 302 constructs citations from the extracted text. In an exemplary embodiment, the citations may be constructed by dividing (or segmenting) each sentence within the attachment (or regulatory event) into its own distinct segment of the set of data. However, in an additional or alternative embodiment, the citations may be constructed (or segmented) according to any delineator, such as by dividing each paragraph, section, or item (such as items within a list) from the attachment (or regulatory event) into its own distinct segment of the attachment (or regulatory event).

At step S616, network compliance controls management tool module 302 identifies regulatory impactful citations. In an exemplary embodiment, network compliance controls management tool module 302 identifies which of the constructed citations actually impact any regulation that governs the management of a technology (e.g., the regulated network) that is managed by network compliance controls management tool module 302. In an exemplary embodiment, the details of the identification of step S616 may be similar to (or substantially the same as) the details of the identification described above with regard to step S404. In an alternative or additional embodiment, the details of the identification of step S616 may be similar to (or substantially the same as) the steps of process 500 of FIG. 5.

After step S616, network compliance controls management tool module 302 decides how to proceed, at step S618, based on whether any of the constructed citations is identified as being an impactful citation. Hence, the identification of step S616 is a basis for the decision of step S618. Accordingly, in the event that network compliance controls management tool module does not identify the regulatory event as being tech impactful (tech related) then, at step S618, network compliance controls management tool module will proceed to step S620. Otherwise, network compliance controls management tool module 302 may actually end (or terminate) process S600 if none of the constructed citations is identified as being a regulatory impactful citation.

At step S620, network compliance controls management tool module 302 recommends at least one technology control. In an exemplary embodiment, the details of the technology control may be determined in a similar manner (or substantially the same manner) as the determination described above with regard to step S416. In an exemplary embodiment, the recommendation of step S620 may include determining one or more respective features, details and/or configurations of each technology control among one or more technology controls.

In an embodiment, the recommendation of step S620 is performed by an AI/ML model, such as one or more from among the first AI/ML model, the second AI/ML model, the third AI/ML model, the fourth AI/ML model, the fifth AI/ML model, the sixth AI/ML model, the seventh AI/ML model, and an eighth AI/ML model that has been trained to determine the one or more technology controls.

At step S622, network compliance controls management tool module 302 identifies control gaps and updates controls catalog. In an exemplary embodiment, the controls catalog includes the list or database of controls are being (or should be) applied to a technology that is managed by network compliance controls management tool module 302. In a further embodiment, the details of the identification of S622 may be similar to (or substantially the same as) the identification described above with regard to step S410. In a further embodiment, the details of the update of S622 may be similar to (or substantially the same as) the implementation of any necessary changes that is described above with regard to step S412.

In an embodiment, after step S622, process 600 may return to step S602 and perform process 600 again with respect to another regulatory event that is distinct from the regulatory event described above. In an additional or alternative embodiment, process 600 may end (or terminate) after step S622. In a further embodiment, after step S622, network compliance controls management tool module 302 may suspend process 600 until network compliance controls management tool module 302 obtains a regulatory event that is distinct from a regulatory event that has been previously obtained.

Accordingly, the present invention provides a system for managing a regulated computer network's compliance controls to maintain the regulated network's compliance with applicable regulations. This network compliance controls management system reduces human errors, provides timely assessments of regulatory impactful information, automates the identification of regulatory information, systematically breaks down (segments/decomposes) monitored regulatory information (e.g., a set of regulatory data), maps appropriate network controls to citations (i.e., one or more particular segment of one or more sets of regulatory data), and enables the maintenance of network controls (such as network compliance controls) to meet today's requirements such as those resulting from the usual frequency of changes to one or more regulations that pertain to a regulated network of a typical enterprise).

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for managing a regulated network of a plurality of network controls to maintain compliance with applicable regulations, the method comprising:
monitoring, at least one network data source, for new regulatory data that pertains to the regulated network;
identifying a first set of new regulatory data that has been obtained from the at least one network data source;
determining whether the first set of new regulatory data requires a first set of changes to a first set of existing network controls from among the plurality of network controls;
after determining that the first set of new regulatory data requires the first set of changes, implementing the first set of changes to the first set of existing network controls;
determining whether the first set of new regulatory data requires modifying the plurality of network controls to include a first set of new network controls that pertain to the network; and
after determining that the first set of new regulatory data requires the modifying, adding the first set of new network controls to the plurality of network controls.

2. The method of claim 1, wherein each respective network control among the plurality of network controls comprises at least one from among: a respective network control categorization that is determined according to a network control hierarchy; and a respective set of relevant keywords and keyphrases that is associated with the respective network control.

3. The method of claim 2, wherein the network control hierarchy comprises: a set of domains that each comprise a set of objectives that each comprise a set of procedures.

4. The method of claim 2, further comprising:
utilizing an artificial intelligence and machine learning (AI/ML) model to perform at least one from among the monitoring, the identifying, the determining whether the first set of changes is required, and the determining whether the modifying is required,
wherein the AI/ML model has been trained with the plurality of network controls.

5. The method of claim 4, wherein the identifying further comprises:
identifying a first set of relevant regulatory data that comprises at least one from among a relevant keyword and a relevant keyphrase; and
identifying when the first set of relevant regulatory data comprises the first set of new regulatory data,
wherein the first set of new regulatory data pertains to a first set of network requirements for which the plurality of network controls does not account.

6. The method of claim 5, further comprising:
determining, based on the at least one from among the relevant keyword and the relevant keyphrase and at least one corresponding relevant network regulation that corresponds to the at least one from among the relevant keyword and the relevant keyphrase, a corresponding network control categorization of the first set of relevant regulatory data.

7. The method of claim 6, wherein the first set of relevant regulatory data comprises the first set of new regulatory data when a first similarity between the corresponding network control categorization and a respective existing network control categorization of each existing network control among the first set of network controls falls below an upper threshold.

8. The method of claim 6, wherein the first set of changes is determined to be required when a second similarity between the corresponding network control categorization and at least one existing network control categorization is above a lower threshold.

9. The method of claim 6, wherein the modifying is determined to be required when a second similarity between the corresponding network control categorization and a respective existing network control categorization of each existing network control among the first set of existing network controls falls below a lower threshold.

10. The method of claim 9, further comprising:
utilizing the AI/ML model to recommend, based on a fourth similarity between the corresponding network control categorization and the respective existing network control categorization of each existing network control, at least one new network control that accounts for the first set of new regulatory data.

11. A system for managing a regulated network of a plurality of network controls to maintain compliance with applicable regulations, the system comprising:
a processor; and
memory storing instructions that, when executed by the processor, cause the processor to perform operations comprising:
monitoring, at least one network data source, for new regulatory data that pertains to the regulated network;
identifying a first set of new regulatory data that has been obtained from the at least one network data source;
determining whether the first set of new regulatory data requires a first set of changes to a first set of existing network controls from among the plurality of network controls;
after determining that the first set of new regulatory data requires the first set of changes, implementing the first set of changes to the first set of existing network controls;
determining whether the first set of new regulatory data requires modifying the plurality of network controls to include a first set of new network controls that pertain to the network; and
after determining that the first set of new regulatory data requires the modifying, adding the first set of new network controls to the plurality of network controls.

12. The system of claim 11, wherein each respective network control among the plurality of network controls comprises at least one from among: a respective network control categorization that is determined according to a network control hierarchy; and a respective set of relevant keywords and keyphrases that is associated with the respective network control.

13. The system of claim 12, wherein the network control hierarchy comprises: a set of domains that each comprise a set of objectives that each comprise a set of procedures.

14. The system of claim 12, wherein the instructions, when executed, cause the processor to perform further operations comprising:
utilizing an artificial intelligence and machine learning (AI/ML) model to perform at least one from among the monitoring, the identifying, the determining whether the first set of changes is required, and the determining whether the modifying is required,
wherein the AI/ML model has been trained with the plurality of network controls.

15. The system of claim 14, wherein the identifying further comprises:
identifying a first set of relevant regulatory data that comprises at least one from among a relevant keyword and a relevant keyphrase; and
identifying when the first set of relevant regulatory data comprises the first set of new regulatory data,
wherein the first set of new regulatory data pertains to a first set of network requirements for which the plurality of network controls does not account.

16. The system of claim 15, wherein the instructions, when executed, cause the processor to perform further operations comprising:
determining, based on the at least one from among the relevant keyword and the relevant keyphrase and at least one corresponding relevant network regulation that corresponds to the at least one from among the relevant keyword and the relevant keyphrase, a corresponding network control categorization of the first set of relevant regulatory data.

17. The system of claim 16,
wherein the first set of relevant regulatory data comprises the first set of new regulatory data when a first similarity between the corresponding network control categorization and a respective existing network control categorization of each existing network control among the first set of network controls falls below an upper threshold,
wherein the first set of changes is determined to be required when a second similarity between the corresponding network control categorization and at least one existing network control categorization is above a lower threshold, and
wherein the modifying is determined to be required when a second similarity between the corresponding network control categorization and a respective existing network control categorization of each existing network control among the first set of existing network controls falls below a lower threshold.

18. A non-transitory computer-readable medium for managing a regulated network of a plurality of network controls to maintain compliance with applicable regulations, the computer-readable medium storing instructions that, when executed by a processor, cause the processor to perform operations comprising:
monitoring, at least one network data source, for new regulatory data that pertains to the regulated network;
identifying a first set of new regulatory data that has been obtained from the at least one network data source;
determining whether the first set of new regulatory data requires a first set of changes to a first set of existing network controls from among the plurality of network controls;
after determining that the first set of new regulatory data requires the first set of changes, implementing the first set of changes to the first set of existing network controls;
determining whether the first set of new regulatory data requires modifying the plurality of network controls to include a first set of new network controls that pertain to the network; and
after determining that the first set of new regulatory data requires the modifying, adding the first set of new network controls to the plurality of network controls.

19. The computer-readable medium of claim 18, wherein each respective network control among the plurality of network controls comprises at least one from among: a respective network control categorization that is determined according to a network control hierarchy; and a respective set of relevant keywords and keyphrases that is associated with the respective network control.

20. The computer-readable medium of claim 19, wherein the instructions, when executed, cause the processor to perform further operations comprising:
utilizing an artificial intelligence and machine learning (AI/ML) model to perform at least one from among the monitoring, the identifying, the determining whether the first set of changes is required, and the determining whether the modifying is required,
wherein the AI/ML model has been trained with the plurality of network controls.
